(19) United States
(12) Patent Application Publication
(10) Pub. No.: US 2026/0260050 A1
(43) Pub. Date: Sep. 3, 2026

(54) Timing Prediction Model for Programmable Integrated Circuit Devices

(71) Applicant: Altera Corporation, San Jose, CA (US)

(72) Inventors: Selvin Quadros, San Jose, CA (US); Mahesh Iyer, Fremont, CA (US)

(21) Appl. No.: 19/656,952

(22) Filed: Apr. 23, 2026

(51) Int. Cl. G06F 30/392; G06F 30/398

(52) U.S. Cl. CPC G06F 30/392; G06F 30/398

(57) ABSTRACT

In an aspect, a non-transitory, computer-readable medium, may include computer-readable instructions that cause a data processing system to receive register-transfer level (RTL) code specifying a system design to be implemented on a programmable integrated circuit device and compile the RTL code to generate a configuration file. The data processing system may compile the RTL code based on a placement operation associated with positioning programmable logic elements in a programmable fabric of the programmable integrated circuit device. While compiling the RTL code, the data processing system also may predict, via a pretrained machine learning model, interconnect delays associated with signal propagation timing between pairs of the programmable logic elements, where the interconnect delays are predicted independent of a routing operation. The data processing system also may compile the RTL code based on the routing operation associated with communicatively coupling the programmable logic elements in the programmable fabric.

### BACKGROUND

The present disclosure relates generally to integrated circuits and, more specifically, to systems and methods for predicting critical path interconnect delays in programmable integrated circuit devices.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Modern electronics, such as computers, portable devices, network routers, data centers, Internet-connected appliances, and the like, tend to include at least one integrated circuit device. Integrated circuit devices may take on a variety of forms, including processors, memory devices, and programmable integrated circuit devices, to name only a few examples. Programmable integrated circuit devices, such as field programmable gate arrays (FPGAs), may include a programmable fabric of logic that a designer may program and reprogram after manufacturing with system designs for various operations. While programming and/or reprogramming a programmable integrated circuit device, it may be desirable to determine timing resources and delays associated with the system design. However, accurately determining timing resources and/or delays on the programmable integrated circuit device may demand compiling the system design to a routing step, where a compiler may identify physical wired connections between resources in the programmable fabric of the programmable integrated circuit device. The routing step may be relatively late in the compiling process and may be resource and time intensive.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device;

FIG. 2 is a block diagram of an example of the integrated circuit device of FIG. 1;

FIG. 3 is a diagram of a data processing system with design software, including a timing prediction model, for configuring a programmable integrated circuit device;

FIG. 4 is an example of a design implementation flow for configuring the programmable integrated circuit device of FIG. 3;

FIG. 5 is an example of a critical path in the programmable fabric of the programmable integrated circuit device of FIG. 3;

FIG. 6 is a flowchart illustrating a method of training the timing prediction model of FIG. 3;

FIG. 7 is a flowchart illustrating a method for the design software of FIG. 3 to predict interconnect delays associated with critical paths before the routing step in the design implementation flow of FIG. 4; and

FIG. 8 is a block diagram of a data processing system that may incorporate the systems and methods of this disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

As mentioned, programmable integrated circuit devices may include a programmable fabric that a designer (e.g., anyone configuring or reconfiguring the programmable logic device) may interact with to cause the programmable integrated circuit device to perform desired operations. In some cases, a designer may describe a system design for a programmable integrated circuit device using Register-Transfer Level (RTL) code. For example, the designer may provide a system design (e.g., a user design, a digital hardware design, a configuration, a circuit design) in a hardware description language (HDL) file using RTL code that defines an application to be implemented on the programmable integrated circuit device and/or an intended behavior of the programmable integrated circuit device. The designer may use design software to generate a configuration file for configuring the programmable integrated circuit device based on the system design. More specifically, the design software may compile the system design into the configuration file, which may be used to configure and/or reconfigure the programmable fabric of the programmable integrated circuit device.

In some aspects, the compiler may generate the configuration file based on a design implementation flow. The compiler may synthesize and/or fit the system design onto the programmable integrated circuit device based on a series of steps defined in the design implementation flow. For example, the design implementation flow may include synthesizing the system design based on an elaboration step, an optimization step, and a technology mapping step. The elaboration step may include translating RTL code to a design netlist of generic logic gates. The optimization step may include optimizing the design netlist for various metrics, such as limiting occupied area on the programmable integrated circuit device and optimizing timing associated with the design netlist. The technology mapping step may include creating basic logic elements (e.g., lookup tables (LUTs) and flip-flops) based on the design netlist. The design implementation flow also may include fitting the system design to a programmable integrated circuit device based on number of steps. For example, a planning step may include periphery placement of programmable logic elements and global clock allocation. A placement step may include clustering the basic logic elements (e.g., LUTs and flip-flops) in the design netlist to programmable logic elements such as adaptive logic modules (ALMs) and/or logic array blocks (LABs). At this step, the fitter also may infer programmable logic blocks (e.g., block digital signal processing (DSP), block random access memory (RAM)). The fitter may cluster and infer these blocks based on the legal constraints (e.g., technical specifications) of the programmable integrated circuit device, the available physical resources on the programmable integrated circuit device, and/or optimization algorithms. A routing step may include connecting programmable resources (e.g., the programmable logic elements and programmable logic blocks) in the programmable fabric of the programmable integrated circuit device based on available routing resources. A retiming step may include applying optimizations after the routing step to position and/or reposition registers in the programmable integrated circuit device to improve timing and limit delays. The finalization step may include physical synthesis and critical path optimization. Throughout the design implementation flow, the compiler may analyze timing associated with the system design and apply various optimizations for timing closure to meet the timing constraints set by a designer. For example, in some systems, the compiler may use heuristic algorithms to estimate interconnect delays that are associated with the system design. As used throughout this disclosure, “interconnect delays” refer to the amount of time that it takes a signal to travel from a source node (e.g., a first programmable logic element) to a destination node (e.g., a second programmable logic element) based on a wired connection over the programmable fabric of the programmable logic elements. As will be discussed throughout this disclosure, interconnect delays associated with critical paths on the programmable integrated circuit device may refer to the most significant interconnect delays on the programmable integrated circuit device, which may limit the operational clock frequency of all registers on the programmable integrated circuit device. Thus, reducing any interconnect delay associated with critical paths on the programmable integrated circuit device may improve the timing efficiency and realized clock frequency of the application being configured on the programmable integrated circuit device.

In any case, the routing step in the design implementation flow is the first step that may provide an indication or visibility into the physical connection of wires between resources on the programmable integrated circuit device. In some systems, the compiler may estimate interconnect delays before the routing stage based on heuristic algorithms. However, estimates that are based on heuristic algorithms may be relatively inaccurate until the routing step. According to aspects of the present disclosure, it is recognized that improving the accuracy of predicting interconnect delays at earlier stages of the design implementation flow provides a benefit. For example, providing the compiler with an accurate estimate of interconnect delays at the placement step may enable the compiler to consider the interconnect delays when physically connecting programmable logic elements at the routing step. Accordingly, the compiler may adjust routing techniques associated with critical paths to limit (e.g., reduce) the interconnect delays, which may improve the timing performance of the application being configured on the programmable integrated circuit device. As just one example, the compiler may use the early indication of interconnect delays before the routing step in various optimizations at the planning step, the placement step, and/or during post-placement physical synthesis to attempt to identify critical paths and/or limit interconnect delays associate with said critical paths. Additionally or alternatively, the compiler may generate a timing report that includes an indication of critical paths and corresponding interconnect delays. According to aspects of the present disclosure, because the early indication of interconnect delays provided herein may be more accurate than other systems, the designer may use the timing report to modify and/or improve certain aspects of the system design and further limit the interconnect delays associated with critical paths.

The present disclosure provides this early estimate of interconnect delays in the form of a timing prediction model that may be implemented in design software and trained to predict interconnect delays before the routing step of the design implementation flow. In aspects of the present disclosure, the timing prediction model may be any suitable type of artificial intelligence (AI) model, such as an eXtreme Gradient Boosting (XGBoost) model. The timing prediction model may be trained to predict interconnect delays and/or other timing delays based on local interconnect features and/or global interconnect features at the placement step. However, in some aspects, the timing prediction model may predict interconnect delays at an earlier step in the design implementation flow, such as the planning step, the placement step, or during post-placement physical synthesis. In any case, the timing prediction model may provide the compiler with an indication of interconnect delays associated with critical paths in the system design before the routing step in the design implementation flow, which may enable the compiler to mitigate against such interconnect delays in earlier optimizations and/or during the routing step.

In aspects of the present disclosure, the timing prediction model may be trained to predict interconnect delays based on various timing features that may be identified during the design implementation flow. For example, one feature that may be provided to the timing prediction model may include detailed location information indicating the source and destination node. Another feature that the timing prediction model may use includes congestion information, such as wire counts, cell counts, and feedback wire counts. In some aspects, other features that the timing prediction model may receive include distance information, such as horizontal and vertical distances between source and destination nodes, routing directions, and routing crossings. Further still, the timing prediction model may receive features such as cluster information associated with the source and destination nodes. The timing prediction model may be trained on these features and/or receive these features as inputs during subsequent design implementation flows to identify critical paths and/or predict the interconnect delays associated with the critical paths before the routing step.

In some aspects, the timing prediction model may be trained and/or fine-tuned on a wide body of training data that may correspond to different types of programmable integrated circuit devices, different system designs, different compiling strategies, and the like. Aspects of the present disclosure include systems and methods for generating training data based on applying different compiling strategies and flows to a set of existing system designs (e.g., client system designs, system designs included in manufacturer or vendor library). As will be discussed throughout this disclosure, training the timing prediction model based on this training data and feature engineering may result in a lightweight model (e.g., less than or equal to five megabytes) that may provide an accurate and time-efficient estimate of interconnect delays before the routing step in the design implementation flow.

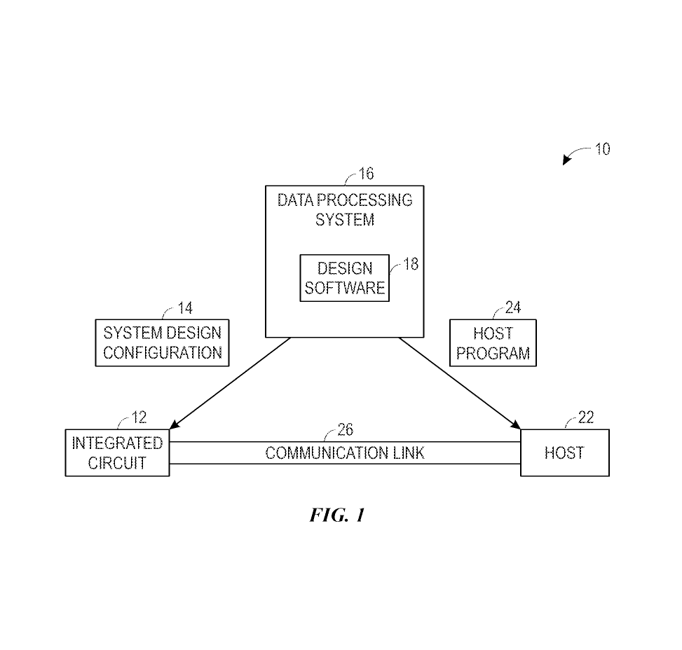

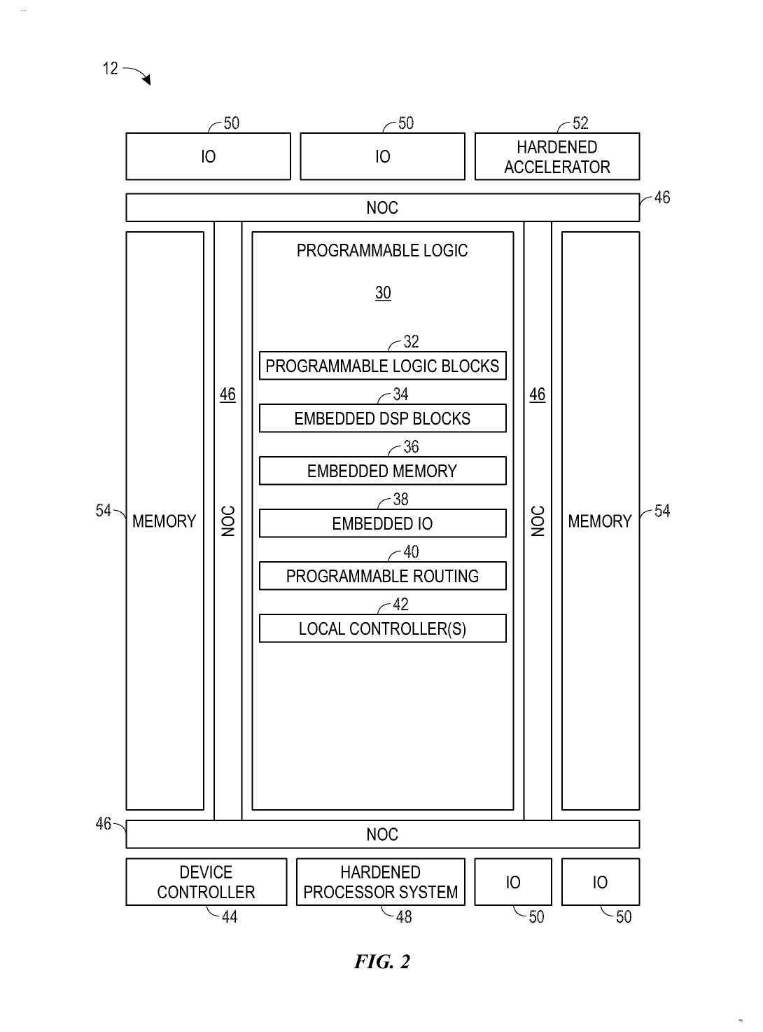

With the foregoing in mind, FIGS. 1 and 2 provide a background on the programmable integrated circuit devices. For example, FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design using a system design configuration 14. Note that, while this disclosure largely refers to the integrated circuit device 12 as being a programmable integrated circuit device, such as an FPGA, in some embodiments, the integrated circuit device 12 may also include a one-time programmable device or structured application specific integrated circuit (ASIC), such as an Altera® eASIC™ device by Altera® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires, via traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system design, a user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18, which may include a compiler (e.g., an RTL compiler) for converting the high-level program into a lower-level description (e.g., a configuration program, a bitstream) as the system design configuration 14. The compiler may provide machine-readable instructions representative of the high-level program to a host 22 and the system design configuration 14 to the integrated circuit device 12. Additionally or alternatively, the compiler may include an RTL-to-RTL compiler that compiles RTL as previously noted or the RTL-to-RTL compiler may be separate from the compiler. As will be discussed in more detail below, the system design configuration 14 may include an application program that may be associated with one or more functions. In particular, the application program may be configured to run the one or more functions on the data processing system 16. For example, the data processing system 16 may execute the application program.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

The integrated circuit device 12 may take any suitable form that may implement the system design configuration 14. In one example shown in FIG. 2, the integrated circuit device 12 may include programmable logic circuitry 30, which may include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table and flip-flops (FFs), effectively enabling any of the programmable logic blocks 32 to implement any desired logic circuitry when configured with the system design configuration 14. The programmable logic blocks 32 are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20kB, blocks of 1MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables (LUTs), logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally, or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

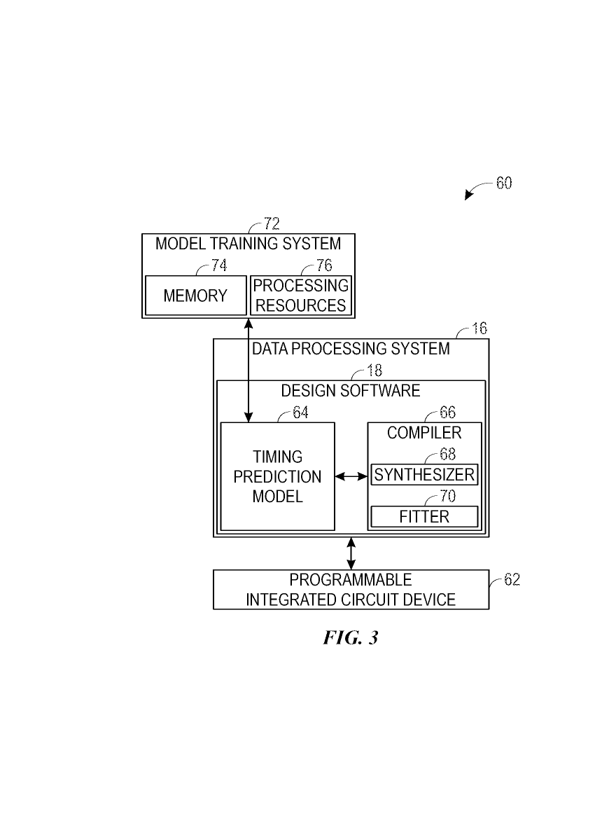

With this background in mind, FIG. 3 is a diagram 60 of a data processing system 16 with design software 18, including a timing prediction model 62, for programming a programmable integrated circuit device 64 (e.g., the integrated circuit device 12 of FIGS. 1 and 2). As described above, the data processing system 16 may be used to configure and/or reconfigure a programmable integrated circuit device 64. Thus, as depicted in this diagram, the data processing system 16 may include (e.g., host) or provide access to design software 18. As depicted, the design software 18 also may include the timing prediction model 62. The timing prediction model 62 may be any suitable model, such as an XGBoost model, a multilayer perceptron model (MLP), a support vector machine (SVM), a Linear Regression model, any other suitable machine learning model, or a combination of multiple machine learning models. In aspects of the present disclosure, the timing prediction model 62 may be a relatively lightweight model (e.g., less than 5 megabytes) that may be installed and accessed locally on a device running the design software 18 (e.g., the timing prediction model 62 may be a local application included in the design software). Additionally or alternatively, the timing prediction model 62 may be hosted on a separate computing device (e.g., a server or collection of servers) that may be accessed by the design software 18, such as over the Internet.

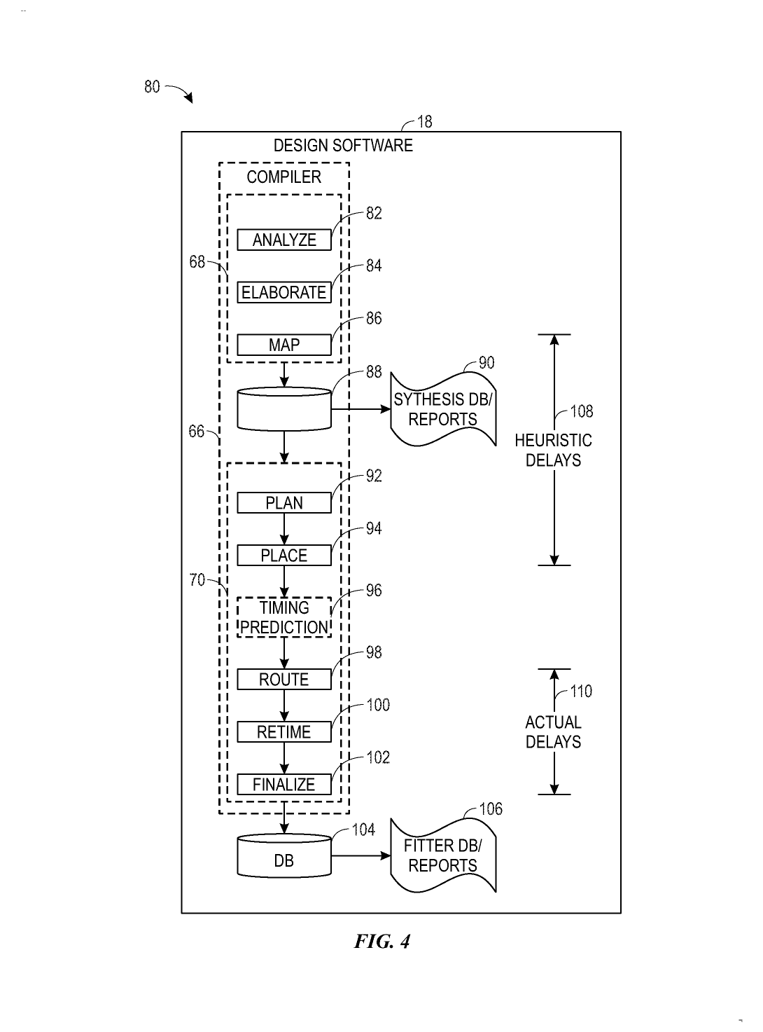

The design software 18 may include a compiler 66 for configuring the programmable integrated circuit device 64. The compiler 66 may include a synthesizer 68 and a fitter 70. As will be discussed with reference to FIG. 4, each of these systems may perform steps in a design implementation flow for configuring a programmable integrated circuit device 64 based on a system design. Although this disclosure describes the synthesizer 68 and the fitter 70 as separate systems within the compiler 66, in some design software implementations the synthesizer 68 and the fitter 70 may be viewed as a common system or collection of processes. In any case, the compiler 66 may receive a system design (e.g., a VHDL or Verilog file including RTL code). The synthesizer 68 may perform elaboration, optimization, and technology mapping on the received system design. For example, the synthesizer 68 may generate a circuit graph of primitives based on the system design. The synthesizer 68 also may generate a technology-mapped netlist for the programmable integrated circuit device 64 based on the design netlist. More specifically, the synthesizer 68 may map the generic logic gates to basic logic elements, such as LUTs and/or flip-flops, which may be implemented on the programmable integrated circuit device 64. In some aspects, the synthesizer 68 also may infer hardened programmable logic blocks (e.g., RAM blocks and/or DSP blocks) that may be implemented on the programmable integrated circuit device 64 based on the circuit graph. The fitter 70 may place and route the technology-mapped netlist onto the programmable integrated circuit device 64. For example, the fitter 70 may cluster basic logic elements (e.g., LUTs and flip-flops) in the technology-mapped netlist to programmable logic elements, such as ALMs, LABs, or other programmable integrated circuit device resources based on the legal constraints and technical specifications (e.g., vendor-specific and/or device-specific configurations) of the programmable integrated circuit device 62. The fitter 70 also may perform clock allocation and retiming for the programmable integrated circuit device 64. In some cases, the fitter 70 may generate a configuration file that may be applied to the programmable integrated circuit device 64 to implement the system design in the programmable fabric of the programmable integrated circuit device 64.

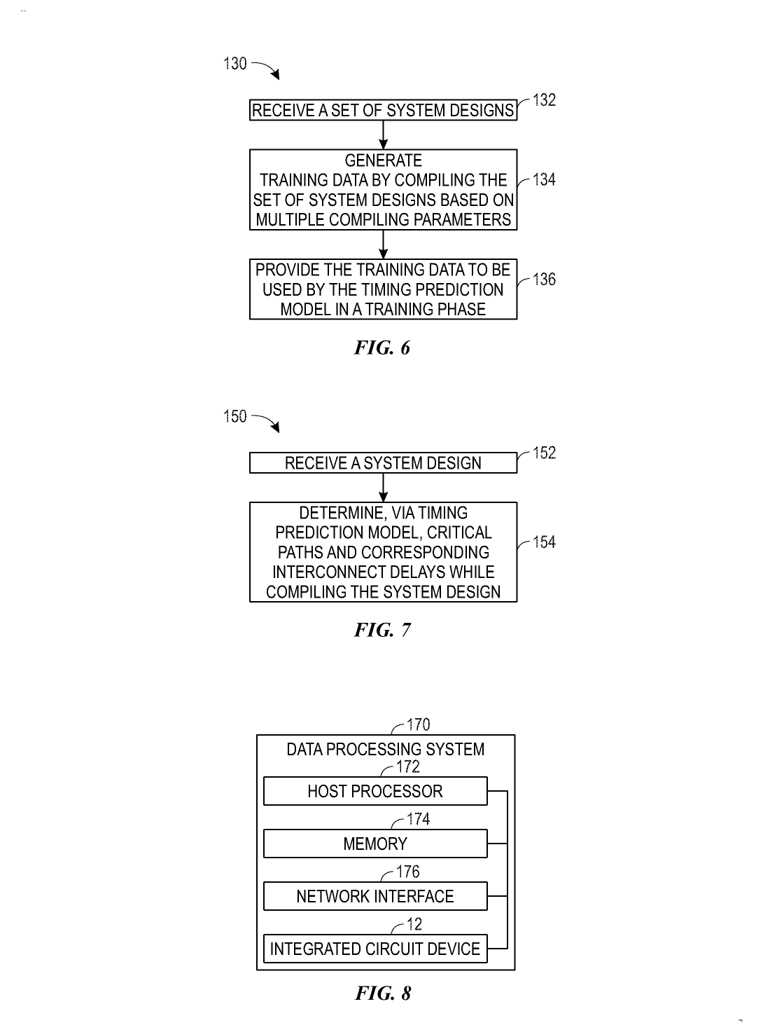

In some aspects, the data processing system 16 may be communicatively coupled to a model training system 72. More specifically, the timing prediction model 62 may be communicatively coupled to the model training system 72. The model training system 72 may be any suitable computing device or collection of computing devices, such as a desktop, a server, a collection of servers, or the like. As will be described with reference to FIG. 6, the model training system 72 may generate training data and/or provide the training data to the timing prediction model 62. The timing prediction model 62 may use the training data received from the model training system 72 during an initial training phase and/or during subsequent refining or fine-tuning phases. The model training system 72 may include memory 74 and processing resources 76 (e.g., processing circuitry, one or more processors). The memory 74 may include non-transitory, computer-readable media that may store instructions, which may be executed by the processing resources 76 to perform operations described herein, including generating synthetic training data and/or providing the training data to the timing prediction model 62. Although depicted as a separate system in this example, in some aspects, the model training system 72 may be included in the data processing system 16 and/or the design software 18.

Turning to a more detailed description of the design implementation flow, FIG. 4 is an example of a design implementation flow 80 for configuring a programmable integrated circuit device 64. According to aspects of this disclosure, the design implementation flow 80 includes an intermediate timing prediction stage that includes the timing prediction model 62 generating an estimate of interconnect delays. The design implementation flow 80 depicted in this example describes a number of discrete steps that may be performed by the compiler 66 during configuration of the programmable integrated circuit device 64. More specifically, the design implementation flow 80 may be broken down into a first stage synthesis steps performed by the synthesizer 68 and a second stage of fitter steps that may be performed by the fitter 70. The design implementation flow 80 may begin with design software 18 receiving RTL code (e.g., a VHDL or Verilog file) indicating a system design to be implemented in programmable fabric of the programmable integrated circuit device 64. After receiving the RTL code, the synthesizer 68 may generate a netlist based on the RTL code. In an analysis step 82, the synthesizer 68 may parse the RTL code for syntax and/or semantic errors. The synthesizer 68 also may create a design tree or another suitable representation of the system design. In an elaboration step 84, the synthesizer 68 may translate the RTL code into the generic logic gates. For example, in the case of an FPGA, the compiler 66 may convert statements in the RTL code into basic FPGA primitive logic gates, such as multiplexers, registers, and/or logic gates. The synthesizer 68 also may perform early optimizations, such as removing logic that does not drive an output and/or resolving definite parameters (e.g., set values).

After the elaboration step 84, the design implementation flow 80 may include an optimization step. At the optimization step, the synthesizer 68 may optimize the design netlist based on timing optimizations, area optimizations, or both. The design implementation flow 80 also may include a technology mapping step 86. In the technology mapping step 86, the synthesizer 68 may generate a technology-mapped netlist based on the design netlist. The technology-mapped netlist may be a technology dependent representation of the design netlist (e.g., for a particular programmable integrated circuit device architecture). To generate the technology-mapped netlist, the synthesizer 68 may simplify logic in the design netlist (e.g., using Boolean algebra to simplify complex logic). The synthesizer 68 also may determine shared hardware resources. In some aspects, the synthesizer 68 may map the generic logic gates to basic logic elements. For example, the synthesizer 68 may replace and/or group the generic logic gates into LUTs and/or flip flops. At this stage, the synthesizer 68 also may infer hardened programmable logic blocks (e.g., DSP blocks, RAM blocks). Additionally or alternatively, the synthesizer 68 may infer carry chain elements and/or adder chains. After the technology mapping step 86 and before the technology-mapped netlist is fit to the programmable integrated circuit device 64, the technology-mapped netlist may be stored in a data structure 88 (e.g., a database, a repository). For example, the technology-mapped netlist may be stored in the data structure to limit re-synthesis time if certain aspects or portions of the technology-mapped netlist are changed (e.g., due to designer changes to the system design). Additionally, the data structure 88 may store the technology-mapped netlist for implementation on multiple programmable integrated circuit devices (e.g., different programmable integrated circuit devices). According to aspects of the present disclosure, after generating the technology-mapped netlist at the technology mapping step 86, the design implementation flow 80 may provide a post-synthesis report 90. The post-synthesis report 90 may include an indication as to programmable resources used by the system design, such as predicted number of ALMs that may be used by the system design, predicted number of LABs that may be used by the system design, more granular basic elements or programmable logic primitives (e.g., LUTs, flip-flops) that may be used by the system design, and additional features that may be included in the system design.

After generating the technology-mapped netlist, the design implementation flow 80 may include a number of fitting steps. In a planning step 92, the fitter 70 may locate dedicated hardware blocks in the programmable integrated circuit device 64. For example, the fitter 70 may locate RAM blocks, DSP blocks, I/O pins, phase-locked loop (PLL) blocks, and the like. At the planning step 92, the fitter 70 also may perform periphery placement of programmable logic elements and global clock allocation. At a placement step 94, the fitter 70 may cluster (e.g., assign) the basic logic elements (e.g., LUTs and/or flip-flops) to programmable logic elements, such as adaptive logic modules (ALMS) and/or Logic Array Blocks (LABs). The fitter 70 also may apply various optimization techniques to limit (e.g., reduce, minimize) wire length, interconnect delay, and/or wire congestion during the routing of the programmable logic circuit elements. In some aspects, after the placement step, the timing prediction model 62 may generate an estimate of interconnect delays. For example, at a timing prediction step 96, the timing prediction model 62 may evaluate multiple paths between programmable logic elements (e.g., or primitives within said elements, hardened programmable logic blocks, and the like. The timing prediction model 62 may determine interconnect delays associated with each of these paths and identify the critical paths on the programmable integrated circuit device 64 based on the predicted interconnect delays. As mentioned, the critical paths may refer to the paths associated with the most significant interconnect delays (e.g., based on an absolute comparison between paths; based on a threshold comparison between each path and a predefined delay threshold). In additional or alternative aspects, the timing prediction step 96 also may occur earlier in the design implementation flow 80, such as after the technology mapping step 86, the planning step 92, and/or after a post-placement physical synthesis that may be associated with logic restructuring and time and area optimizations after the placement step 94. In any case, the timing prediction step 96 may demand a nominal amount of timing and computing resources relative to the other steps in the design implementation flow 80. As will be discussed in more detail below, the timing prediction model 62 may provide an advantage in terms of an early identification of critical paths and prediction of interconnect delays, which may enable the compiler 66 to perform delay-aware optimizations at earlier stages in the design implementation flow. Moreover, the timing prediction model 62 may provide interconnect delays that are more accurate than interconnect delays that may be determined without aspects of the present disclosure (e.g., using heuristic algorithms). For example, the predicted interconnect delays generated by the timing prediction model 62 may be significantly more accurate than traditional heuristic methods. For example, in some cases, the timing prediction model 62 may predict interconnect delays within a threshold accuracy (e.g., 85% accurate, 90% accurate, 95% accurate) relative to actual interconnect delays that may be determined at a later stage in the design implementation flow (e.g., at the end of the design implementation flow 80, after a routing step 98 in the design implementation flow 80). This accuracy increase may provide a substantial benefit over heuristic algorithms, which may not provide a reliable indication of interconnect delays and may, therefore, provide limited use in earlier stages of the design implementation flow 80 and/or be of limited value to the designer in timing reports generated before the routing step 98. For example, by having an early indication of predicted interconnect delays that is accurate relative to the actual interconnect delays after the routing step 98, the compiler 66 may reliably use the predicted interconnect delay in timing and/or area optimizations at earlier stages in the design implementation flow 80.

Continuing with the design implementation flow 80, at the routing step 98, the fitter 70 may connect the placed programmable logic circuit elements within the programmable integrated circuit device 64 using interconnect resources. In some aspects, the fitter 70 may map connections between programmable logic circuit elements over the routing fabric based on timing constraints and specifications. During the placement step 94 and/or the routing step 98 the fitter 70 may optimize wiring usage, set-up timing and hold timing, apply algorithms to reduce routing congestions, and confirm that the placed logic circuit elements comply with legal constraints (e.g., vendor and/or device specifications) and practical constraints (e.g., that physical resources on programmable integrated circuit device 64 are not overutilized). Additionally, during these steps, the fitter 70 may use placement information to cluster the basic logic elements (e.g., LUTs and/or flip-flops) into ALMs and/or LABs based on the legal constraints of the FPGA and/or optimize the clustering of the programmable logic circuit elements based on their respective functions. At a retiming step 100, the fitter may perform sequential optimizations by moving programmable logic elements and/or logic cells (e.g., registers) across the combinational logic to limit path delays and/or improve potential operating frequency. At a finalization step 102, the fitter 70 may finalize timing by adding delays to fix any hold violations. In some aspects, the fitter 70 may output a configuration file at the finalization step 102. The configuration file may include a bitstream that may be applied (e.g., pushed) to the programmable integrated circuit device 64 to configure or reconfigure the programmable integrated circuit device 64. After the finalization step 102, the configuration file may be stored in a data structure 104 (e.g., a database, a repository). The data structure 104 may be the same as the data structure 88 described above or it may be a separate data structure. In some cases, the design implementation flow 80 may provide a post-fit report 106 at this stage. For example, some design implementation flows 80 may use heuristics and/or artificial intelligence systems and methods to generate the post-fit report 106 based on resource allocations and definitions included in the configuration file.

As mentioned above, in the disclosed design implementation flow 80, the timing prediction model 62 may predict interconnect delays at a pre-routing steps of the design implementation flow 80. For example, in some systems the compiler 66 may estimate heuristic delays 108 before the placement step 94 and determine actual interconnect delays 110 after the routing step 98. However, according to the present disclosure, the compiler 66 may leverage machine learning systems and methods (e.g., via the timing prediction model 62) to estimate the actual delays 110 (e.g., the interconnect delays) at earlier steps in the design implementation flow 80. In some aspects, the compiler 66 may use the predicted interconnect delays to predict a maximum operating frequency of the programmable integrated circuit device 64 (also referred to as f_{MAX}). The maximum operating frequency may refer to the maximum rate at which the programmable integrated circuit device 64 may update the outputs of registers, which may be affected by a propagation delay of signals across the programmable logic. For example, the paths on the programmable integrated circuit device 64 that may be associated with large propagation delays (e.g., relative to other connections on the programmable integrated circuit device 64) may be referred to as a critical path that may limit the operational speed of the programmable integrated circuit device. Thus, by determining interconnect delays associated with multiple paths on the programmable integrated circuit device 64, the timing prediction model 62 may identify potential critical paths before the routing step 98. As described above, this information may be provided to the compiler 66 to adjust (e.g., apply pre-routing optimizations to) the potential critical paths to improve the operational timing of the programmable integrated circuit device 64.

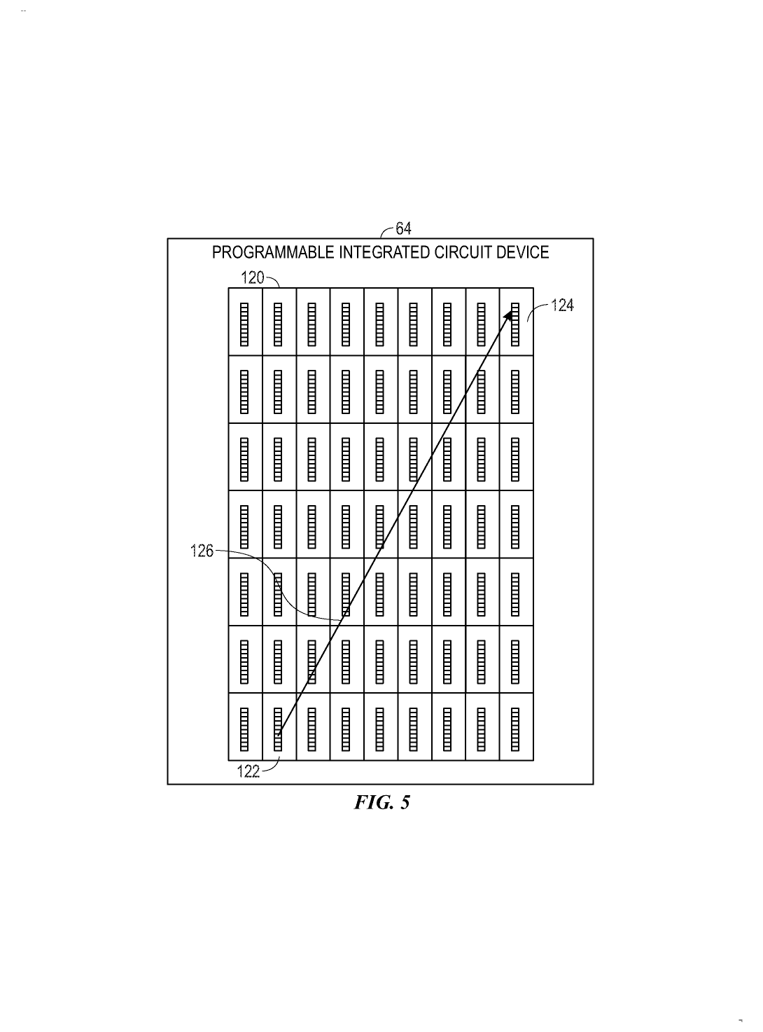

Turning now to an example of a path that may experience an interconnect delay, FIG. 5 is an example of a critical path in the programmable fabric 120 of the programmable integrated circuit device 64. For example, in this case a first LAB may include a collection of ALMs. One of the ALMs may be a source node 122. An I/O pin of the source node 122 may be coupled to an I/O pin of a destination node 124. The destination node 124 may be another ALM in another LAB. The other LAB may be placed in a different area of the programmable fabric 120. The source node 122 may be coupled to the destination node 124 via a wire 126. In this example, the wire 126 includes a direct (e.g., shortest path) connection between the source node 122 and the destination node 124. However, in other cases, the wire 126 may be routed to include detours (e.g., to avoid wire congestion in the programmable fabric 120). In any case, because the source node 122 is located relatively far from the destination node 124 in the programmable fabric 120, it may be a critical path that may affect the maximum operating frequency of the programmable integrated circuit device 64.

With this example in mind, the timing prediction model 62 may be trained on various features to predict the interconnect delay associated with the critical path depicted in FIG. 5. Turning now to a more detailed look at this training process, FIG. 6 is a flowchart illustrating a method 130 of training the timing prediction model 62. Although the following description of the method 130 is described as being performed by the model training system 72, any suitable computing device (e.g., any device having a processor and memory), including the timing prediction model 62 itself, may perform the steps described herein. Although the method 130 is described in a particular order, it should be understood that the method 130 may be performed in any suitable order and may exclude one or more of the blocks described herein.

At block 132, the model training system 72 may receive a set of system designs for multiple programmable integrated circuit devices. The set of system designs may include system designs for different types of devices that may demand varying amounts of resources and include varying amounts of congestion. For example, some of the system designs may have relatively little routing congestion whereas other system designs may have significant routing congestion. The set of system designs may refer to actual system designs that have been previously implemented using design software 18. In some aspects, the set of system designs may be defined in a library that may be associated with a manufacturer, vendor, or developer of programmable integrated circuit devices. In other aspects, the set of system designs may include customer designs and/or open source Intellectual Property (IP) cores (e.g., OpenCores). In any case, at block 132, the set of system designs may refer to system designs that have been previously implemented and/or validated. Accordingly, the set of system designs may be viewed as training data. However, as may be appreciated, access to system designs may be limited and there is an indeterminable number of possible connections (e.g., paths) between programmable logic elements that could be implemented on a programmable logic device. Thus, additional training data may be useful for training, refining, and fine-tuning the timing prediction model 62.

At block 134, the model training system 72 may generate training data by compiling the set of system designs to determine interconnect delays using various compiling parameters. More specifically, the model training system 72 may implement each system design using different compiling strategies and/or implementation flows. As an example, in some aspects, the model training system 72 may compile each received system design (block 132) multiple times with different placement seeds and/or routing seeds (e.g., initial routing locations for programmable logic circuit elements). In some aspects, each of the received system designs may be compiled using different compiling parameters. For example, the model training system 72 may compile the system designs with different timing constraints (e.g., clock definitions, input/outputs delays, multi-cycle paths demands, false path commands), physical and location constraints (e.g., forced floor planning, mandated pin assignments), optimization and implementation strategies (e.g., congestion limitations, logic duplication settings, area optimization preferences, speed optimization settings), and/or any other suitable compiling strategies. The model training system 72 may compile each system design in the set of system designs multiple times to generate training data. The training data may include an indication of the compiled system design and a corresponding interconnect delay (e.g., an actual or measured delay determined at the end of the design implementation flow 80). In some aspects, the model training system 72 may selectively engage compiling parameters to generate targeted training data. For example, if the initial set of system designs includes a limited number of system designs associated with high congestion under standard compiling conditions, the model training system 72 may selectively recompile the high congestion system designs using different parameters to generate additional training data associated with a high degree of congestion. In additional or alternative aspects, the model training system 72 may select system designs and compiling constraints using a random or pseudo-random selection algorithm. In some aspects, the model training system 72 may be configured to iteratively compile the system designs using different compiling strategies until it has generated a threshold amount of training data. For example, the model training system 72 may be configured to compile the set of system designs or a portion of the set of system designs using different compiling parameters until the model training system 72 generates data indicative of 1,000 interconnect delays, 100,000 interconnect delays, or any suitable number of interconnect delays. In at least these ways, the model training system 72 may use different compiling strategies and parameters to generate a wide set of training data.

At block 136, the model training system 72 may provide the training data to the timing prediction model 62 to be used by the timing prediction model 62 during training. In some aspects, the timing prediction model 62 may be an XGBoost model or another suitable machine learning model (e.g., a supervised or unsupervised machine learning model). As an example, in cases where the timing prediction model 62 is an XGBoost model, the timing prediction model 62 may receive the training data from the model training system (block 134) and train multiple decision trees based on a training algorithm, such as gradient boosting with a least-squares loss. The timing prediction model 62 may sequentially add and train decision trees to limit (e.g., reduce) any residual prediction errors. In some aspects, the timing prediction model 62 may be trained based on a number of hyperparameters, including a maximum tree depth, a number of trees, and/or a learning rate. Moreover, the timing prediction model 62 may be tuned based on regularization parameters (e.g., L1/L2 regularization) by applying a grid search on a validation set (e.g., a set of the received system designs compiled under a set of standard or predefined compiling parameters at block 134). The timing prediction model 62 may output a number of inferences, including potential critical paths, interconnect delays associated with the critical paths, scaled f_{MAX} rates, and/or the like. After training, the timing prediction model 62 may be implemented in the design software 18. More specifically, the timing prediction model 62 may receive a system design (e.g., from a designer) and may predict interconnect delays for each path that may be included in the programmable fabric 120 of the programmable integrated circuit device 64 before the routing step 98 in in the design implementation flow 80.

In some aspects, the timing prediction model 62 may be trained based on feature engineering. For example, the timing prediction model 62 may be trained on “K” timing features with the highest correlation to interconnect delays (e.g., based on comparing mutual information scores between interconnect delays and various features), where “K” may be any positive integer. Turning to a few examples of the timing features that the timing prediction model may be trained on and/or use to predict interconnect delays after training, the timing prediction model 62 may receive an indication of detailed location information of the source node 122 and the destination node 124. In some aspects, the detailed location information may include a granular identification of an I/O pin location of the source node 122 and an I/O pin of the destination node 124. Further, the detailed location information may include a pin index, a sub-block index, a type of pin (e.g., a data pin, a control pin), and a programmable logic cell type (e.g., an indication of whether the node is a LUT, a flip flop, block RAM, block DSP) for both the source node 122 and destination node 124.

In some aspects, the timing prediction model may receive an indication of congestion information. The congestion information may include wire counts in the programmable fabric 120, counts of programmable logic cells (e.g., LUTs, flip-flops, block RAM, block DSP) in the programmable fabric 120, and/or a count of feedback wires in the programmable fabric 120. The congestion information may be determined for a portion of the programmable fabric 120 based on a column-by-column evaluation. For example, in some aspects, the timing prediction model 62 may consider congestion metrics for each column within a bounding box that includes the source node 122 and the destination node 124. Looking back to the example of the programmable fabric 120 in FIG. 5, the timing prediction model 62 may receive the congestion information for the column that includes the source node 122, the column that includes the destination node 124, and the six intermediate columns.

In some aspects, the timing prediction model 62 may receive an indication of distance information between the source node 122 and the destination node 124. For example, the timing prediction model 62 may receive a horizontal distance between an I/O pin of the source node 122 and an I/O pin of the destination node 124, a vertical distance between the I/O pin of the source node and the I/O pin of the destination node 124, and/or a diagonal distance between the I/O pin of the source node 122 and the I/O pin of the destination node 124. The distance information also may include a number of block RAM and/or block DSP columns between the I/O pin of the source node 122 and the I/O pin of the destination node 124. Further, in some aspects, the distance information may include a direction of the path between the I/O pin of the source node 122 and the I/O pin of the destination node 124. For example, the distance information may include a direction of the destination node 124 relative to the source node 122.

In some aspects, the timing prediction model may receive an indication of cluster information. The cluster information may be pre-determined information (e.g., before the routing step 98) that provides an indication of the timing constraints of I/O pins in close locational proximity the source node 122 and/or the destination node 124. For example, in some cases, the cluster information may include the number of I/O pins within a threshold distance of the source node 122 or the destination node 124 that have timing constraints (e.g., predefined input or output hold times) that are greater than or equal to a timing threshold. In some aspects, the timing prediction model 62 may receive one or more indications as to categorical features of the system design, such as a programmable integrated circuit device type or family. The categorical features also may include enabled settings on the programmable integrated circuit device 64, such as whether the device is balanced, high-effort, area-optimized, and/or the like. The timing prediction model 62 may use any or all of these timing features during a training phase and/or during subsequent inference phases when it is implemented in the design software 18.

Indeed, after training the timing prediction model 62, the timing prediction model 62 may be implemented in the design software 18 to inference critical paths and interconnect delays during the design implementation flow 80. Turning to an example use case for the timing prediction model 62, FIG. 7 is a flowchart illustrating a method 150 for design software 18 to predict interconnect delays associated with critical paths before the routing step 98 in the design implementation flow 80 of FIG. 4. Although the following description of the method 150 is described as being performed by the design software 18 that includes a timing prediction model 62, other types of design software that may include or may access other suitable models also may perform this method 150. Additionally, although the method 150 is described in a particular order, it should be understood that the method 150 may be performed in any suitable order and may exclude one or more of the blocks described herein.

At block 152, the design software 18 may receive a system design for a programmable integrated circuit device 64. The system design may be drafted or provided from a designer and may include one or more desired behaviors to be implemented on a programmable integrated circuit device 64.

At block 154, the design software 18 may determine, via a timing prediction model 62, one or more critical paths and corresponding interconnect delays while compiling the system design. More specially, the timing prediction model 62 may predict critical paths and their corresponding interconnect delays before the routing step 98 in the design implementation flow 80. As mentioned above, the timing prediction model 62 may use a number of features for predicting critical paths and timing delays. In some aspects, the timing prediction model 62 may evaluate pairs of programmable logic cells (e.g., LUTs, flip-flops, block RAM, block DSP) to be communicatively coupled via wires. The timing prediction model 62 may identify interconnect delays for each of these paths and identify critical paths based on the predicted interconnect delays associated with each of these paths. For example, the timing prediction model may estimate the interconnect delays for each path between programmable logic cells (e.g., source nodes and destination nodes) and determine which paths are critical paths based on a set of paths being associated with a relatively high propagation delay (e.g., a propagation delay greater than an absolute timing threshold, a propagation delay greater than a relative threshold to other paths in the programmable fabric, a greatest propagation delay). The timing prediction model 62 may identify the interconnect delays associated with each path using timing features, such as detailed location information between programmable logic elements, congestion information associated with the path between the programmable logic elements, distance information between the programmable logic elements, cluster information associated with the programmable logic elements, categorical information related to the programmable integrated circuit device 64 associated with the system design (e.g., optimization settings, legal constraints), combinations of these factors, and/or the like.

In some aspects, after the timing prediction model 62 has predicted the interconnect delays and/or identified the predicted critical paths, the design software 18 (e.g., the compiler 66) may leverage the predicted interconnect delays during the design implementation flow 80. For example, the design software 18 may use the interconnected delays to prioritize placing between certain programmable resources, such as programmable logic cells (e.g., at the placement step 96 in the design implementation flow 80). In some cases, the design software 18 may use the predicted interconnect delays in optimization algorithms at earlier stages in the design implementation flow 80 (e.g., in various optimizations at the planning step 92). Additionally or alternatively, the design software 18 may generate a timing report, which may be displayed or transmitted to the designer. In some aspects, the designer may use the timing report to adjust the system design. For example, the designer may use the timing report to attempt to reduce any interconnect delays associated with the system design, increase the operational timing of the system design, floorplan the design, choose a different device that may be better suited for the system design, or the like. After updating the system design, the designer may recompile the system design to determine if any changes have improved the interconnect delays on the programmable integrated circuit device 64. Accordingly, this method 150 may be used by a designer in an iterative manner to edit and improve a system design for an application to be mapped and fitted onto the programmable integrated circuit device 64.

With the preceding in mind, the integrated circuit device 12 discussed above may be a component included in a data processing system, such as a data processing system 170, shown in FIG. 8. The data processing system 170 may include the integrated circuit device 12 (e.g., a programmable logic device, an application specific integrated circuit (ASIC)), a host processor 172, memory and/or storage circuitry 174, and a network interface 176. The data processing system 170 may include more or fewer components (e.g., electronic display, user interface structures, application specific integrated circuits (ASICs)). Moreover, any of the circuit components depicted in FIGS. 4, 6, and 8 may include the NOC 46 of the integrated circuit device 12. The host processor 172 may include any of the foregoing processors that may manage a data processing request for the data processing system 170 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 174 may include random access memory (RAM), read-only memory (ROM), one or more hard drives, flash memory, or the like. The memory and/or storage circuitry 174 may hold data to be processed by the data processing system 170. In some cases, the memory and/or storage circuitry 174 may also store configuration programs (e.g., bitstreams) for programming the integrated circuit device 12. The network interface 176 may allow the data processing system 170 to communicate with other electronic devices. The data processing system 170 may include several different packages or may be contained within a single package on a single package substrate. For example, components of the data processing system 170 may be located on several different packages at one location (e.g., a data center) or multiple locations. For instance, components of the data processing system 170 may be located in separate geographic locations or areas, such as cities, states, or countries.

The data processing system 170 may be part of a data center that processes a variety of different requests. For instance, the data processing system 170 may receive a data processing request via the network interface 176 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

### EXAMPLE EMBODIMENT 1

A non-transitory, computer-readable medium, comprising computer-readable instructions that, when executed by a data processing system, cause the data processing system to:

receive register-transfer level (RTL) code specifying a system design to be implemented on a programmable integrated circuit device;

compile the RTL code to generate a configuration file for the programmable integrated circuit device, wherein compiling the system design comprises:

a placement operation comprising positioning a plurality of programmable logic elements in a programmable fabric of the programmable integrated circuit device;

a prediction operation, via a pretrained machine learning model, comprising predicting one or more interconnect delays associated with signal propagation timing between one or more pairs of the programmable logic elements, wherein the interconnect delays are predicted independent of a routing operation; and

the routing operation comprising communicatively coupling the programmable logic elements in the programmable fabric.

### EXAMPLE EMBODIMENT 2

The non-transitory, computer-readable medium of example embodiment 1, wherein compiling the system design comprises:

identifying a critical path of a plurality of paths between the one or more pairs of programmable logic elements before the routing operation based on a path between a pair of the programmable logic elements affecting a maximum operating frequency (f_{MAX}) of the programmable integrated circuit device.

### EXAMPLE EMBODIMENT 3

The non-transitory, computer-readable medium of example embodiment 1, wherein each of the one or more pairs of the programmable logic elements comprises a source element and a destination element.

### EXAMPLE EMBODIMENT 4

The non-transitory, computer-readable medium of example embodiment 3, wherein the pretrained machine learning model is configured to predict an interconnect delay for each pair of the one or more pairs of programmable logic elements based on location information associated with an input/output (I/O) pin of the source element and an I/O pin of the destination element, congestion information associated with the source element or the destination element, distance information associated with the source element and the destination element, cluster information associated with the source element or the destination element, or any combination thereof.

### EXAMPLE EMBODIMENT 5

The non-transitory, computer-readable medium of example embodiment 1, wherein the instructions cause the data processing system to:

output a timing report before the routing operation, wherein the timing report comprises the one or more interconnect delays predicted by the pretrained machine learning model; and

determine one or more actual routing delays after the routing operation, wherein the one or more interconnect delays predicted by the pretrained machine learning model are within a threshold accuracy of the one or more actual interconnect delays.

### EXAMPLE EMBODIMENT 6

The non-transitory, computer-readable medium of example embodiment 1, wherein the pretrained machine learning model is trained to estimate interconnect delays for an application being mapped and fitted onto the programmable integrated circuit device based on a device type and one or more settings associated with the programmable integrated circuit device.

### EXAMPLE EMBODIMENT 7

The non-transitory, computer-readable medium of example embodiment 1, wherein the instructions cause the data processing system to:

receive an indication comprising one or more changes to the RTL code or an alternative programmable integrated circuit device for implementing the system design; and

predict, via the pretrained machine learning model, one or more changes to the one or more interconnect delays based on the indication.

### EXAMPLE EMBODIMENT 8

The non-transitory, computer-readable medium of example embodiment 1, wherein the instructions cause the data processing system to use the one or more predicted interconnect delays before the routing operation in one or more timing optimizations at the placement operation, at a planning operation, at a post-placement physical synthesis operation, or any combination thereof.

### EXAMPLE EMBODIMENT 9

The non-transitory, computer-readable medium of example embodiment 1, wherein the instructions cause the data processing system to provide the configuration file to the programmable integrated circuit device to cause the programmable integrated circuit device to perform one or more operations associated with the system design.

### EXAMPLE EMBODIMENT 10

A non-transitory, computer-readable medium, comprising computer-readable instructions that, when executed by a data processing system, cause the data processing system to:

receive a system design to be implemented on a programmable integrated circuit device; and

determine, via a timing prediction model, one or more critical paths and corresponding interconnect delays of the system design independent of a routing operation.

### EXAMPLE EMBODIMENT 11

The non-transitory, computer-readable medium of example embodiment 10, wherein the timing prediction model is trained to determine the one or more critical paths based on operations comprising:

identifying a plurality of paths between a plurality of source and destination nodes to be communicatively coupled as part of the routing operation, wherein the plurality of source and destination nodes comprise lookup tables (LUTs), flip-flops, digital signal processing (DSP) blocks, or random access memory (RAM) blocks, and wherein each path of the plurality of paths comprises a source node and a destination node;

determining interconnect delays for each of the plurality of paths based on a plurality of timing features; and

identifying the one or more critical paths and the corresponding interconnect delays based on the determined interconnect delays for a set of paths of the plurality of paths.

### EXAMPLE EMBODIMENT 12

The non-transitory, computer-readable medium of example embodiment 11, wherein the timing features comprise location information associated with a source node and a destination node for each of the plurality of paths, wherein the location information comprises a location of an input/output (I/O) pin of the source node and an I/O pin of the destination node, a type of the I/O pin of the source node, a type of the I/O pin of the destination node, a type programmable logic cell of the source node, a type of programmable logic cell of the destination node, or any combination thereof.

### EXAMPLE EMBODIMENT 13

The non-transitory, computer-readable medium of example embodiment 11, wherein the timing features comprise congestion information associated with a source node or a destination node for each of the plurality of paths, wherein the congestion information comprises a count of wires in one or more columns between an input/output (I/O) pin of the source node and an I/O pin of the destination node, a count of programmable logic cells in the one or more columns, a count of feedback wires in the one or more columns, or any combination thereof.

### EXAMPLE EMBODIMENT 14

The non-transitory, computer-readable medium of example embodiment 11, wherein the timing features comprise distance information between a source node and a destination node for each of the plurality of paths, wherein the distance information comprises a horizontal distance between an input/output (I/O) pin of the source node and an I/O pin of the destination node, a vertical distance between the I/O pin of the source node and the I/O pin of the destination node, a count of RAM columns between the I/O pin of the source node and the I/O pin of the destination node, a count of DSP columns between the I/O pin of the source node and the I/O pin of the destination node, a direction of the I/O pin of the destination node relative to the I/O pin of the source node, or any combination thereof.

### EXAMPLE EMBODIMENT 15

The non-transitory, computer-readable medium of example embodiment 11, wherein the timing features comprise cluster information associated with a source node or a destination node for each of the plurality of paths, wherein the cluster information comprises a first count of input/output (I/O) pins with timing constraints greater than or equal to a threshold timing level within a threshold distance of the source node, a second count of I/O pins with timing constraints greater than or equal to the threshold timing level within the threshold distance of the destination node, or both.

### EXAMPLE EMBODIMENT 16

The non-transitory, computer-readable medium of example embodiment 10, wherein the instructions cause the data processing system to generate training data to provide to the timing prediction model based on:

receiving a set of system designs for a plurality of programmable integrated circuit devices;

compiling the set of system designs using a plurality of compiling parameters to generate a set of training data; and

providing the set of training data to the timing prediction model to be used by the timing prediction model during a training phase.

### EXAMPLE EMBODIMENT 17

The non-transitory, computer-readable medium of example embodiment 16, wherein compiling the set of system designs using the plurality of compiling parameters comprises compiling at least one system design in the set of system designs multiple times using different placement seeds, routing seeds, or both.

### EXAMPLE EMBODIMENT 18

A method comprising:

receiving a set of system designs for programmable integrated circuit devices;

generating training data from the set of system designs based on iteratively:

selecting a set of compiling parameters;

compiling a system design in the set of system designs using the set of compiling parameters;

determining an interconnect delay associated with the compiled system design; and

storing the interconnect delay and the compiled system design as a part of the training data; and

providing the training data to a timing prediction model to be used to train the timing prediction model to predict interconnect delays in a subsequent system design.

### EXAMPLE EMBODIMENT 19

The method of example embodiment 18, wherein generating the training data from the set of system designs comprises repeating the iterative operations until a count of the stored interconnect delays and compiled system designs is greater than or equal to a threshold amount of training data.

### EXAMPLE EMBODIMENT 20

The method of example embodiment 18, wherein selecting the set of compiling parameters comprises selecting a compiling parameter based on one or more compiling features or selecting the compiling parameter based on a pseudo-random selection algorithm.

What is claimed is:

1. A non-transitory, computer-readable medium, comprising computer-readable instructions that, when executed by a data processing system, cause the data processing system to:
receive register-transfer level (RTL) code specifying a system design to be implemented on a programmable integrated circuit device; and
compile the RTL code to generate a configuration file for the programmable integrated circuit device, wherein compiling the system design comprises:
a placement operation comprising positioning a plurality of programmable logic elements in a programmable fabric of the programmable integrated circuit device;
a prediction operation, via a pretrained machine learning model, comprising predicting one or more interconnect delays associated with signal propagation timing between one or more pairs of the programmable logic elements, wherein the interconnect delays are predicted independent of a routing operation; and
the routing operation comprising communicatively coupling the programmable logic elements in the programmable fabric.

2. The non-transitory, computer-readable medium of claim 1, wherein compiling the system design comprises:
identifying a critical path of a plurality of paths between the one or more pairs of programmable logic elements before the routing operation based on a path between a pair of the programmable logic elements affecting a maximum operating frequency (f_{MAX}) of the programmable integrated circuit device.

3. The non-transitory, computer-readable medium of claim 1, wherein each of the one or more pairs of the programmable logic elements comprises a source element and a destination element.

4. The non-transitory, computer-readable medium of claim 3, wherein the pretrained machine learning model is configured to predict an interconnect delay for each pair of the one or more pairs of programmable logic elements based on location information associated with an input/output (I/O) pin of the source element and an I/O pin of the destination element, congestion information associated with the source element or the destination element, distance information associated with the source element and the destination element, cluster information associated with the source element or the destination element, or any combination thereof.

5. The non-transitory, computer-readable medium of claim 1, wherein the instructions cause the data processing system to:
output a timing report before the routing operation, wherein the timing report comprises the one or more interconnect delays predicted by the pretrained machine learning model; and
determine one or more actual routing delays after the routing operation, wherein the one or more interconnect delays predicted by the pretrained machine learning model are within a threshold accuracy of the one or more actual interconnect delays.

6. The non-transitory, computer-readable medium of claim 1, wherein the pretrained machine learning model is trained to estimate interconnect delays for an application being mapped and fitted onto the programmable integrated circuit device based on a device type and one or more settings associated with the programmable integrated circuit device.

7. The non-transitory, computer-readable medium of claim 1, wherein the instructions cause the data processing system to:
receive an indication comprising one or more changes to the RTL code or an alternative programmable integrated circuit device for implementing the system design; and
predict, via the pretrained machine learning model, one or more changes to the one or more interconnect delays based on the indication.

8. The non-transitory, computer-readable medium of claim 1, wherein the instructions cause the data processing system to use the one or more predicted interconnect delays before the routing operation in one or more timing optimizations at the placement operation, at a planning operation, at a post-placement physical synthesis operation, or any combination thereof.

9. The non-transitory, computer-readable medium of claim 1, wherein the instructions cause the data processing system to provide the configuration file to the programmable integrated circuit device to cause the programmable integrated circuit device to perform one or more operations associated with the system design.

10. A non-transitory, computer-readable medium, comprising computer-readable instructions that, when executed by a data processing system, cause the data processing system to:
receive a system design to be implemented on a programmable integrated circuit device; and
determine, via a timing prediction model, one or more critical paths and corresponding interconnect delays of the system design independent of a routing operation.

11. The non-transitory, computer-readable medium of claim 10, wherein the timing prediction model is trained to determine the one or more critical paths based on operations comprising:
identifying a plurality of paths between a plurality of source and destination nodes to be communicatively coupled as part of the routing operation, wherein the plurality of source and destination nodes comprise lookup tables (LUTs), flip-flops, digital signal processing (DSP) blocks, or random access memory (RAM) blocks, and wherein each path of the plurality of paths comprises a source node and a destination node;
determining interconnect delays for each of the plurality of paths based on a plurality of timing features; and
identifying the one or more critical paths and the corresponding interconnect delays based on the determined interconnect delays for a set of paths of the plurality of paths.

12. The non-transitory, computer-readable medium of claim 11, wherein the timing features comprise location information associated with a source node and a destination node for each of the plurality of paths, wherein the location information comprises a location of an input/output (I/O) pin of the source node and an I/O pin of the destination node, a type of the I/O pin of the source node, a type of the I/O pin of the destination node, a type programmable logic cell of the source node, a type of programmable logic cell of the destination node, or any combination thereof.

13. The non-transitory, computer-readable medium of claim 11, wherein the timing features comprise congestion information associated with a source node or a destination node for each of the plurality of paths, wherein the congestion information comprises a count of wires in one or more columns between an input/output (I/O) pin of the source node and an I/O pin of the destination node, a count of programmable logic cells in the one or more columns, a count of feedback wires in the one or more columns, or any combination thereof.

14. The non-transitory, computer-readable medium of claim 11, wherein the timing features comprise distance information between a source node and a destination node for each of the plurality of paths, wherein the distance information comprises a horizontal distance between an input/output (I/O) pin of the source node and an I/O pin of the destination node, a vertical distance between the I/O pin of the source node and the I/O pin of the destination node, a count of RAM columns between the I/O pin of the source node and the I/O pin of the destination node, a count of DSP columns between the I/O pin of the source node and the I/O pin of the destination node, a direction of the I/O pin of the destination node relative to the I/O pin of the source node, or any combination thereof.

15. The non-transitory, computer-readable medium of claim 11, wherein the timing features comprise cluster information associated with a source node or a destination node for each of the plurality of paths, wherein the cluster information comprises a first count of input/output (I/O) pins with timing constraints greater than or equal to a threshold timing level within a threshold distance of the source node, a second count of I/O pins with timing constraints greater than or equal to the threshold timing level within the threshold distance of the destination node, or both.

16. The non-transitory, computer-readable medium of claim 10, wherein the instructions cause the data processing system to generate training data to provide to the timing prediction model based on:
receiving a set of system designs for a plurality of programmable integrated circuit devices;
compiling the set of system designs using a plurality of compiling parameters to generate a set of training data; and
providing the set of training data to the timing prediction model to be used by the timing prediction model during a training phase.

17. The non-transitory, computer-readable medium of claim 16, wherein compiling the set of system designs using the plurality of compiling parameters comprises compiling at least one system design in the set of system designs multiple times using different placement seeds, routing seeds, or both.

18. A method comprising:
receiving a set of system designs for programmable integrated circuit devices;
generating training data from the set of system designs based on iteratively:
selecting a set of compiling parameters;
compiling a system design in the set of system designs using the set of compiling parameters;
determining an interconnect delay associated with the compiled system design; and
storing the interconnect delay and the compiled system design as a part of the training data; and
providing the training data to a timing prediction model to be used to train the timing prediction model to predict interconnect delays in a subsequent system design.

19. The method of claim 18, wherein generating the training data from the set of system designs comprises repeating the iterative operations until a count of the stored interconnect delays and compiled system designs is greater than or equal to a threshold amount of training data.

20. The method of claim 18, wherein selecting the set of compiling parameters comprises selecting a compiling parameter based on one or more compiling features or selecting the compiling parameter based on a pseudo-random selection algorithm.
